(19) United States
(12) Patent Application Publication
(10) Pub. No.: US 2013/0211926 A1
(43) Pub. Date: Aug. 15, 2013

(54) SYSTEM AND METHOD FOR PROVIDING INTEGRATED MARKETPLACE

(71) Applicant: NHN Business Platform Corporation, (US)

(72) Inventors: Jin-Woo CHOI, Seongnam-si (KR); HyangCheol LEE, Seongnam-si (KR); Sujin JEON, Seongnam-si (KR); Dongbin OH, Seongnam-si (KR); Yunkyung CHO, Seongnam-si (KR); Young-Sun LEE, Seongnam-si (KR)

(73) Assignee: NHN BUSINESS PLATFORM CORPORATION, Seongnam-si (KR)

(21) Appl. No.: 13/708,056

(22) Filed: Dec. 7, 2012

(30) Foreign Application Priority Data
Feb. 10, 2012 (KR) 10-2012-0013887

(51) Int. Cl. G06Q 30/02

(52) U.S. Cl. CPC G06Q 30/0277
USPC 705/14.73

(57) ABSTRACT

Provided is a system and method for providing an advertisement that provides an integrated e-marketplace in a portal site managing system that provides a plurality of services including at least one of a shopping information providing service, a web document searching service, a personal page managing service, and a payment service.

### CROSS-REFERENCE TO RELATED APPLICATION

This application claims priority from and the benefit of Korean Patent Application No. 10-2012-0013887, filed on Feb. 10, 2012, which is hereby incorporated by reference in its entirety for all purposes as if fully set forth herein.

### BACKGROUND OF THE INVENTION

1. Field of the Invention

Exemplary embodiments of the present invention relate to a system and method for providing an advertisement that provides an integrated e-marketplace.

2. Discussion of the Background

E-commerce or E-business may refer to business conducted between a company and a consumer over the Internet and the like. An E-marketplace is a mediator that connects a supplier and a consumer through new media such as the Internet and the like. A key to the e-marketplace is to connect the supplier and the consumer independent of a supplying company. A large portion of profits may result from a commission earned from transactions being closed. A portion of the e-marketplace may have a profit model such as a registration fee and the like. A company may reduce a risk in dealing with unidentified companies with the reliability of the e-marketplace, and costs may decrease as a process of purchasing goods is simplified through establishing a procurement system between the e-marketplace and companies.

FIG. 1 is a diagram illustrating a platform structure of an e-marketplace according to related art. The e-marketplace according to the related art may include a registering platform 110 to register information about a product for sale, a publishing platform 120 to publish information with respect to a registered product, and an affiliate platform 130 for an affiliate marketing scheme. The affiliate marketing scheme is a technique employed to increase traffic and sales by gathering an affiliate 140 such as, an e-commerce merchant site advertising a website of a consumer. For example, when a performance result is obtained through the affiliate site as in a pay-for-performance scheme, an advertising fee may be paid to the affiliate 140.

Here, the registering platform 110 may be operated through a system of an online auction or an online shopping mall company, such as, Auction or eBay. The publishing platform 120 may be operated through a system that provides a personal webpage service, a system of a portal site that provides a café, a blog, or a mini-homepage, and the like, or a system of a reward website. Also, the affiliate platform 130 may be operated through a system of a company providing the affiliate marketing scheme. That is, each platform may be operated as a separate system in the conventional art.

### SUMMARY OF THE INVENTION

Exemplary embodiments of the present invention provide a system and method for providing an advertisement to an integrated e-marketplace by processing a registration, a display, a sale, and a payment of a product integrally.

Exemplary embodiments of the present invention also provide a system and method for providing an advertisement by utilizing services provided by a portal site system that processes a registration, a display, a sale, and a payment of a product integrally.

Exemplary embodiments of the present invention also provide a system and method for providing an advertisement that enhances an advertising effect by providing a predetermined reward to a user working as an affiliate through an affiliate platform for an affiliate marketing, as well as providing an integrated e-marketplace by processing a registration, a display, a sale, and a payment integrally.

Additional features of the invention will be set forth in the description which follows, and in part will be apparent from the description, or may be learned by practice of the invention.

An exemplary embodiment of the present invention discloses a system for providing an advertisement on a portal site system, the system comprising: a processor; a product information receiver configured to receive information about a product input to a personal page assigned to a portal site member subscribing a personal page managing service; a product register configured to register the product and associated product information; and a payment processor configured to process a payment related to sale of the registered product when the associated product information is displayed through at least one of a personal page, a shopping information service, and a web document searching service.

An exemplary embodiment of the present invention discloses a method of providing an advertisement on a portal site system, the method comprising: receiving information about a product input to a personal page assigned to a portal site member subscribing the personal page managing service; registering, in a storage unit, the product and associated product information; and processing a payment related to sale of the registered product when the associated product information is displayed through at least one of a personal page, a shopping information service, and a web document searching service.

An exemplary embodiment of the present invention discloses one or more non-transitory computer-readable storage media having stored thereon a computer program that, when executed by one or more processors, causes the one or more processors to perform acts that provide an advertisement, comprising: receiving information about a product input to a personal page assigned to a portal site member subscribing the personal page managing service; registering, in a storage unit, the product and associated product information; and processing a payment related to sale of the registered product when the associated product information is displayed through at least one of a personal page, a shopping information service, and a web document searching service. It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a platform structure of an e-marketplace according to related art.

FIG. 2 illustrates an overview of a portal site system and a system for providing an advertisement according to an exemplary embodiment of the present invention.

FIG. 3 illustrates an overview of a method for providing an advertisement according to an exemplary embodiment of the present invention.

FIG. 4 illustrates a process of exchanging information with respect to a product through a social networking service according to an exemplary embodiment of the present invention.

FIG. 5 illustrates a platform structure according to an exemplary embodiment of the present invention.

FIG. 6 is a block diagram illustrating an internal configuration of a system for providing an advertisement according to an exemplary embodiment of the present invention.

FIG. 7 is a flowchart illustrating a method for providing an advertisement according to an exemplary embodiment of the present invention.

### DETAILED DESCRIPTION OF THE ILLUSTRATED EMBODIMENTS

Exemplary embodiments of the present invention will be described in detail with reference to the accompanying drawings. These exemplary embodiments will be described in detail for those skilled in the art in order to practice the present invention. It should be appreciated that various exemplary embodiments of the present invention are different but do not have to be exclusive. For example, specific shapes, configurations, and characteristics described in an exemplary embodiment of the present invention may be implemented in another exemplary embodiment without departing from the spirit and the scope of the present invention. In addition, it should be understood that position and arrangement of individual components in each disclosed exemplary embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawings. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing exemplary embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

Hereinafter, exemplary embodiments of the present invention are described in detail with reference to the accompanying drawings.

It will be understood that when an element is referred to as being “connected to” another element, it can be directly connected to the other element, or intervening elements may be present.

Exemplary embodiments of the present invention are directed to a system for providing an advertisement and a method executed by a system for providing an advertisement. The system for providing the advertisement may include a portal site system that provides various services to users like a portal site or a system included in the portal site system.

FIG. 2 is a diagram illustrating an overview of a portal site system 210 and a system for providing an advertisement 220 according to an exemplary embodiment of the present invention. Referring to FIG. 2, the system for providing the advertisement 220 is included in the portal site system 210. Here, the portal site system 210 may provide a portal site 240 to a user requesting access through a user terminal 230, and provide various services through the portal site 240.

The various services provided to users through the portal site 240 may correspond to a shopping information providing service, a web document searching service, a personal page managing service, a social networking service, a payment service, and the like. The shopping information providing service may include a product searching service for shopping. The web document searching service may include a service that provides specific webpages through conducting a search corresponding to a keyword that is input. The personal page managing service may include a service that assigns and manages a page of a specific Uniform Resource Locator (URL) to a personal user subscribing as a member to a blog, a café, or a mini-homepage. A webpage for an advertisement search may be included in a webpage provided by the web document searching service. A social networking service may indicate a service that enables users on a web to form a human network. The social networking service may be combined with a Personal Web Environment (PWE) or the personal page managing service.

The system for providing the advertisement 220 included in the portal site system 210 may be provided directly or be connected to a plurality of services including at least one of the shopping information providing service, the web document searching service, the personal page managing service, the social networking service, and the payment service. The system for providing the advertisement 220 may register a product through a personal page assigned to a user subscribing as a member, and display information with respect to a registered personal page or a registered product using at least one of the various aforementioned services to users.

In some embodiments, the portal site 240 and the various services provided by the portal site 240 may be utilized for the integrated e-marketplace through the system for providing the advertisement 220.

In some embodiments, when information with respect to a registered personal page or a registered product is uploaded through a social networking service and a purchase of a product occurs through the uploaded information, the system for providing the advertisement 220 may provide a predetermined reward to a user uploading the information. That is, the system for providing the advertisement 220 may include an affiliate platform to perform affiliate marketing. A main publisher for the affiliate marketing may utilize the various services provided by the portal site 240.

For example, a system can include: a service A for providing advertisement 220 or portal site system 210 and information with respect to a product registered on a personal page B, personal page B can be uploaded by a user b or a user c through the service A. When a user d purchases the product through the uploaded information by visiting the personal page B, the predetermined reward may be provided to the user c uploading the information.

Also, as described above, the social networking service may be utilized in conjunction with the personal page managing service that provides and manages a personal page such as a blog, a café, or a mini-homepage. The purchase of the product itself may be conducted through the personal page on which the product is registered for a first time. That is, the information uploaded through the social networking service may include a link to the personal page on which the product is registered for the first time. In the example described above, the user c makes a clipping of or uploads the registered product information onto the personal page B of the user b from a personal page C of the user c. A link to the personal page B may be set in the uploaded information of the product. In this instance, when the user d visiting the personal page C purchases the product by visiting the personal page B through the link, the system for providing the advertisement 220 may provide the predetermined reward to the user c.

The predetermined reward may be provided as reserved points and the like. The reserved points are managed either by the portal site system 210, or provided only to users uploading information through the social networking service, or the personal page for a first time when necessary. As used herein, the “reserved points” may be defined as a unit of value used in reality. The reserved points may be represented as cyber money or points or mileage corresponding to the money used in reality. For example, when necessary, the cyber money may be represented liberally such as cyber money that has a value of a 1:1 ratio to the money used in reality or cyber money that has a value of a 1:10 ratio to the money used in reality, and the like.

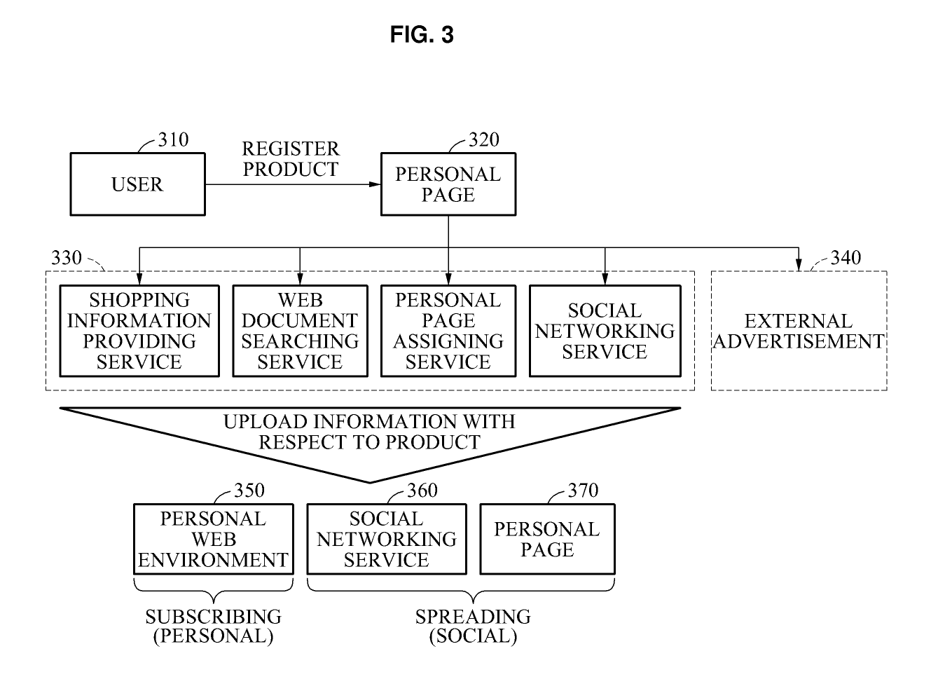

FIG. 3 illustrates a method for providing an advertisement according to an exemplary embodiment of the present invention. A user 310 may register a product through a personal page 320 assigned to the user 310. Here, a system for providing an advertisement may display information with respect to a product or a personal page 320 through various services 330. For example, the system for providing the advertisement may display the information using a shopping information providing service when searching for a product, or display the information by including the information in a result found through use of a web document searching service. Also, the system for providing the advertisement may display information through a café, a blog, a mini-homepage, and the like, using a personal page managing service, or display the information through a social networking service. Further, the system for providing the advertisement may display the information through an external advertisement 340. As used herein, the “external advertisement” 340 may indicate another portal site or another publisher.

As used herein, a “publisher” may be referred to as a “site”. A site can include a website connection of a personal computer (PC). A site can include execution using unusual website connections, such as an application screen implemented in a mobile terminal, and the like. The “site” may be compatible with a “publishing site” or the “publisher”. In some embodiments, each site may correspond to an individual publisher. The “site” may include a type of website through which an advertisement may be displayed and provided via a wired/wireless network to a user, and indicate a single webpage configuring a website.

“Displaying” information of an advertisement, a product, and the like, may be interpreted as providing promotional content to a visitor of a corresponding site, such as a text, an image, a sound, a video, a hyperlink, and the like, associated with an advertiser through the site or the publisher.

A “selection” with respect to the displayed advertisement may indicate an occurrence of a situation intended to be achieved by the advertiser through delivering the promotional content, by displaying the advertisement and triggering a response with a mouse click or the like. The promotional content can include the provided text, the image, and the like. For example, the advertiser may include a situation in which a page associated with the advertiser is displayed to a user upon selection of an advertisement.

In some embodiments, other users may subscribe to the displayed information. That is, information may be provided to users applying to subscribe to the displayed information through a Personal Web Environment (PWE) 350 to a personal space of the users. This permits ready verification of information in the personal space. The personal space may indicate a space that provides a personal web storage space. The personal space can be provided through a personal webpage that supports a housekeeping book service, a calendar service, a schedule management or a combination thereof. That is, the users may be able to verify the information provided to the personal webpage with convenience and ease in an environment in which an Internet connection is available. Information that the users subscribe to may be provided to the personal space either periodically based on a condition set by the users or when the information corresponds to a set condition.

The displayed information may be uploaded, that is, spread, through the social networking service 360 or the personal page 370 by users. Information that is displayed once by the users may be displayed to other users secondarily by the users. In this instance, the system for providing the advertisement may provide the predetermined reward to users uploading the information.

Here, although the social networking service 360 and the personal page 370 are illustrated separately in FIG. 3, a blog, a café, a mini-homepage, and the like, may be included in the social networking service 360 in terms of forming a personal relationship with other users. Further, uploading information with respect to a product through the social networking service 260 may include delivering the information with respect to the product through an e-mail.

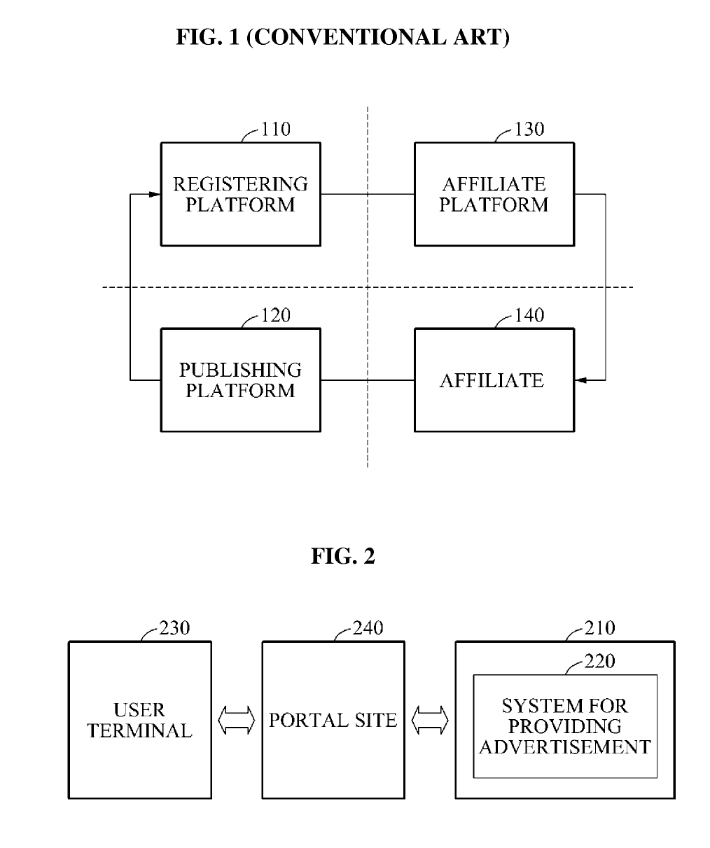

Referring to FIG. 1, the payment service may include a check-out payment service. The check-out payment service may allow users subscribing to a payment service provided by a portal site to efficiently purchase and pay for a product after identification (ID). A payment for purchasing a product on a personal page on which the product is registered may be conducted using the check-out payment service. Also, the check-out payment service may support a payment using reserved points, a voucher, or the like.

By using the system for providing the advertisement according to embodiments in the present invention, an overall process of registering, displaying, selling, and paying of a product may be processed integrally, and affiliate marketing with respect to the product may be processed in a single system integrally.

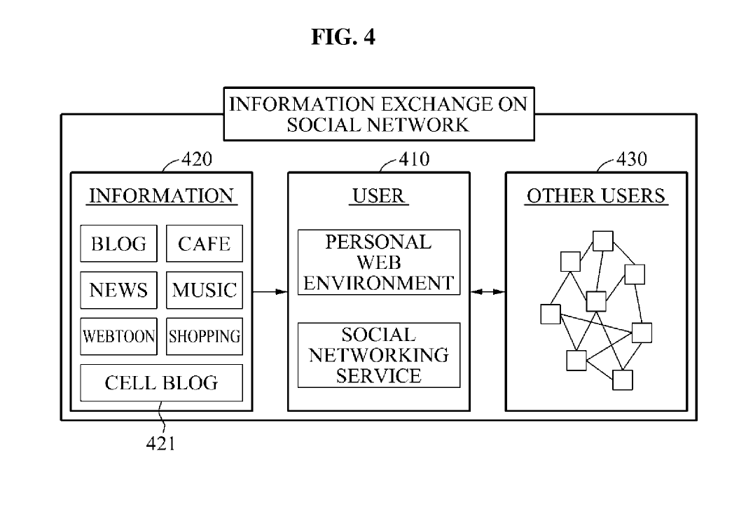

FIG. 4 illustrates a process of exchanging information with respect to a product through a social networking service according to an exemplary embodiment of the present invention.

A user 410 may subscribe to information 420 with respect to a product displayed through various services through a PWE, or upload the information 420 through a social networking service. Information 420 may be displayed in a variety of means such as a blog, a café, news, a webtoon, shopping, and the like. For example, a cell blog 421 may indicate a personal page on which the information 420 is registered. Here, information the user 410 subscribes to via the PWE may be uploaded through the social networking service by the user 410. Also, the information the user 410 subscribes to via the PWE may be set to be uploaded through the social networking service automatically, based on a selection of the user 410. The information 420 uploaded through the social networking service may be displayed to other users 430 forming a personal relationship with the user 410. When at least one of the other users 430 purchases a product through the displayed information 420, a predetermined reward may be provided to the user 410. Here, purchasing of the product may be restricted to a purchase occurring in the cell blog 421. That is, the user 410 may work as an affiliate in an integrated e-marketplace without an additional subscription to a membership.

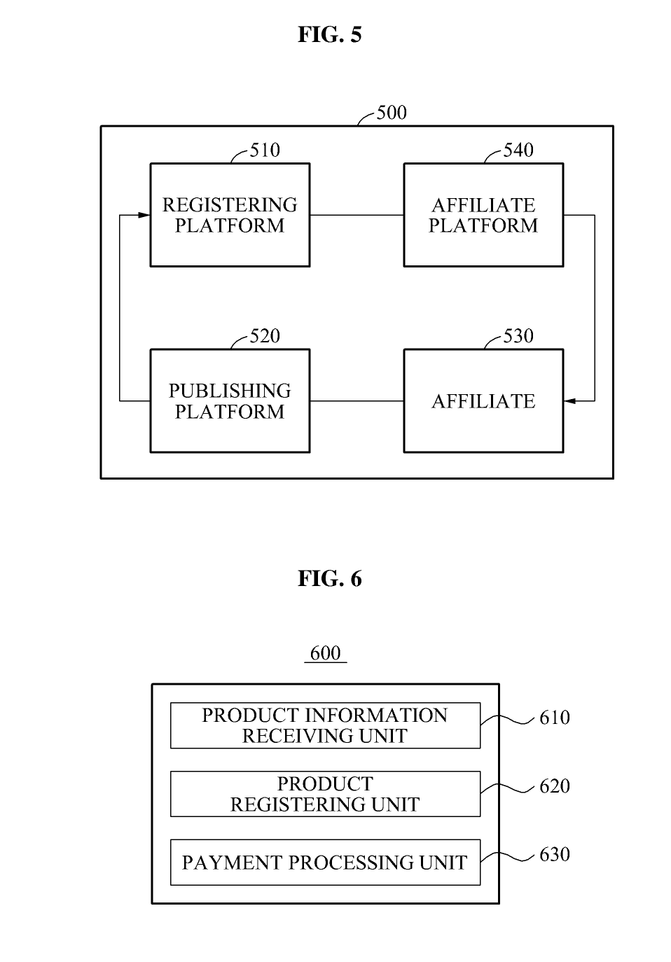

FIG. 5 illustrates a platform structure according to an embodiment of the present invention. A single system 500 including a registering platform 510 that registers information with respect to a product for sale, a publishing platform 520 that publishes information with respect to the registered product, and an affiliate platform 540 that manages a performance of an affiliate 530 and distributes profits. Accordingly, a process of registering, displaying, selling, paying, and distributing of the profits of the product may be conducted integrally through the single system. That is, the integrated e-marketplace may be provided using the various services provided by a single system 500 or portal site.

The registering platform 510 may manage detailed information of a product registered through a cell blog by an additional input of the detailed information, and manage a trending interest or a purchase review by users with respect to the product. Also, the registering platform 510 may receive and manage an input of information with respect to an event or a promotion, and display the information with respect to the event or the promotion through the cell blog.

Here, the publishing platform 520 may be utilized in conjunction with a social networking service to promote information secondarily, with respect to a product, through a buzz marketing scheme or a viral marketing scheme as well as a direct product advertisement using a blog, a café, a mini-homepage, a mail, and the like. The publishing platform 520 may provide traffic to the cell blog by displaying information with respect to the product or the cell blog through the blog, the café, the mini-homepage, the mail, or the social networking service. The publishing platform 520 may be able to provide an advertisement that encourages purchasing a product by attracting the users to the cell blog.

The affiliate 530 may be a member of the portal site system 210 described in FIG. 2. In some embodiments, affiliate 530 may be restricted to members of a check-out payment service provided by the portal site system 210.

The affiliate platform 540 may distribute profits by managing a performance of the affiliate 530. That is, a predetermined reward such as a reserved point or a voucher may be provided to the affiliate 530 encouraging the purchase of the product by uploading the information with respect to the product through the social networking service. That is, members of the payment service may be encouraged to promote the information with respect to the product secondarily to users forming a personal relationship spontaneously.

FIG. 6 illustrates an internal configuration of a system for providing an advertisement 600 according to an embodiment of the present invention. The system for providing the advertisement 600 may include a portal site system that provides a plurality of services including one or more of a shopping information providing service, a web document searching service, a personal page managing service, and a payment service, using a portal site. The system for providing the advertisement 600 may include a product information receiving unit (product information receiver) 610, a product registering unit (product register) 620, and a payment processing unit (payment processor) 630.

The product information receiving unit 610 may receive information with respect to a product that is input to a personal page assigned to a user subscribing to a portal site as a member through the personal page managing service. By way of example, the personal page may correspond to at least one of a blog, a café, or a mini-homepage, and the personal page managing service may indicate a service that manages at least one of the blog, the café, or the mini-homepage. That is, the personal page may be assigned to the user subscribing to the portal site as the member, and a user intending to sell a product may register the product by inputting information with respect to the product in the personal page.

The product registering unit 620 may register a product based on information with respect to the received product. The registered product may be displayed to other users using various services provided by the portal site.

When the information with respect to the registered product is displayed through at least one of a personal page, a shopping information providing service, or a web document searching service and the product is purchased via the displayed information, the r payment processing unit 630 may process a payment related to sale of the product using the payment service.

That is, the system for providing the advertisement 600 may provide an integrated e-marketplace that processes an overall process of registering, displaying, selling, and rewarding for a product integrally using various services provided by the portal site.

The portal site system may further provide a social networking service, and the information with respect to the registered product may further be displayed through the social networking service. In this instance, when a product is purchased via information displayed through the social networking service, the payment processing unit 630 may further process a payment related to the sale of the product using the payment service.

Also, when the information with respect to the displayed product is purchased while being uploaded through the social networking service by at least one of a user subscribing to a portal site as a member and a user subscribing to a payment service as a member, a predetermined reward may be provided to the at least one of the user subscribing to the portal site as the member and the user subscribing to the payment service as the member. That is, an affiliate platform for an affiliate marketing scheme may be included in a single system, and a member subscribing to a portal site or a user subscribing to a payment service may function as an affiliate without an additional subscription to the affiliate platform.

Further, sale of a product may be conducted on a personal page on which information with respect to the product is registered in order to register the product for a first time. For example, when a product is displayed via another means, displayed information may include a link to a personal page, and when a purchase of the product is requested, the personal page may be provided automatically to a user requesting the purchase of the product. In this instance, the purchase of the product may be conducted on the personal page, and the payment processing unit 630 may process the payment related to sale of the product using the payment service. Here, the payment service may include the check-out payment service as described above.

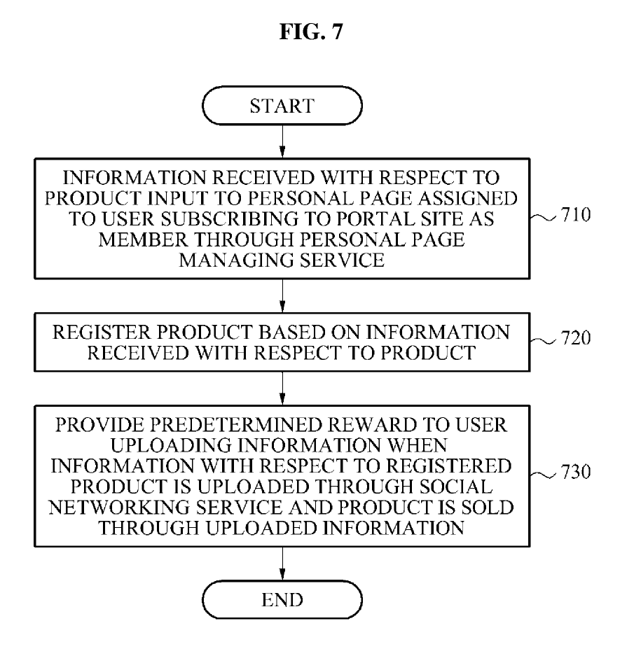

FIG. 7 illustrates a method for providing an advertisement according to an exemplary embodiment of the present invention. The method for providing the advertisement may be conducted by the system for providing the advertisement 600 described in FIG. 6.

In step 710, a system for providing advertisement 600 may receive information with respect to a product that is input to a personal page assigned to a user subscribing to a portal site as a member. For example, the personal page may correspond to at least one of a blog, a café, and a mini-homepage, and a personal page managing service may indicate a service that manages at least one of the blog, the café, and the mini-homepage. That is, the personal page may be assigned to the user subscribing to the portal site as the member, and a user intending to sell a product belonging to the user through the personal page may register the product by inputting information with respect to the product to the personal page.

In step 720, the system for providing advertisement 600 may register a product based on the information with respect to the received product. The registered product may be displayed to other users using various services provided by a portal site.

In step 730, when the information with respect to the registered product is displayed through at least one of a personal page, a shopping information providing service or and a web document searching service, and the product is purchased via the displayed information, the system for providing advertisement 600 may process a payment related to the sale of the product using the payment service.

That is, the system for providing advertisement 600 may provide an integrated e-marketplace that processes an overall process of registering, displaying, selling, and paying of the product integrally using the various services provided by the portal site.

Here, the portal site system may further provide a social networking service, and the information with respect to the registered product may further be displayed through the social networking service. In this instance, when the product is purchased via the information displayed through the social networking service, the system for providing the advertisement 600 may further process a payment related to the sale of the product using the payment service.

Also, when the information with respect to the displayed product is purchased while being uploaded through the social networking service by at least one of a user subscribing to a portal site as a member and a user subscribing to a payment service as a member, a predetermined reward may be provided to the at least one of the user subscribing to the portal site as the member and the user subscribing to the payment service as the member. For example, the predetermined reward may be provided to a user uploading the information with respect to the registered product through the social networking service for a first time. That is, an affiliate platform for an affiliate marketing may be included in a single system, and a member subscribing to a portal site or a member subscribing to a payment service may work as an affiliate without an additional subscription to the affiliate platform.

In some embodiments, the sale of a product may be conducted on a personal page on which information with respect to the product is registered in order to register the product for a first time. For example, when the product is displayed through another route, displayed information may include a link to the personal page, and when a purchase of the product is requested, the personal page may be provided to the user requesting the purchase of the product automatically. The purchasing of the product may be conducted on the personal page, and the system for providing advertisement 600 may process the payment related to sale of the product using the payment service. The payment service may include the check-out payment service as described above.

For any descriptions omitted in FIGS. 6 and 7, reference may be made to analogous features described in FIGS. 2 to 5.

According to exemplary embodiments of the present invention, an integrated e-marketplace may be provided by processing a registration, a display, a sale, and a payment of a product integrally. Also, the registration, the display, the sale, and the payment of the product may be processed integrally by utilizing services provided by a portal site system that operates a portal site. Further, an advertising effect may be enhanced by providing the integrated e-marketplace that processes the registration, the display, the sale, and the payment of the product integrally, and by providing a predetermined reward to a member working as an affiliate through an affiliate platform for affiliate marketing.

According to exemplary embodiments of the present invention, it is possible to provide an integrated e-marketplace by processing a registration, a display, a sale, and a payment of a product integrally.

According to exemplary embodiments of the present invention, it is possible to process a registration, a display, a sale, and a payment of a product integrally by utilizing services provided by a portal site system operating a portal site.

According to exemplary embodiments of the present invention, it is possible to increase an advertising effect by providing a predetermined reward to a user working as an affiliate through an affiliate platform for an affiliate marketing scheme, as well as providing an integrated e-marketplace by processing a registration, a display, and a payment of a product integrally.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for providing an advertisement on a portal site system, the system comprising:
a processor;
a product information receiver configured to receive information about a product input to a personal page assigned to a portal site member subscribing a personal page managing service;
a product register configured to register the product and associated product information; and
a payment processor configured to process a payment related to sale of the registered product when the associated product information is displayed through at least one of a personal page, a shopping information service, and a web document searching service.

2. The system of claim 1, wherein the associated product information of the registered product is displayed through a social networking service provided through the portal site system, and
the payment processor further processes a payment related to the sale of the registered product while the associated product information is displayed through the social networking service.

3. The system of claim 1, wherein the portal site system further provides a social networking service, and
a reward is provided to at least one of a portal site member or a user subscribing to the payment service as a member, when the registered product is purchased after the associated product information is uploaded on the social networking service by at least one of the portal site member or the user subscribing to the payment service as the member.

4. The system of claim 3, wherein the reward is provided to a user uploading the associated product information of the registered product through the social networking service for a first time.

5. The system of claim 1, wherein the sale of the registered product is conducted on the personal page.

6. A method of providing an advertisement on a portal site system, the method comprising:
receiving information about a product input to a personal page assigned to a portal site member subscribing the personal page managing service;
registering, in a storage unit, the product and associated product information; and
processing a payment related to sale of the registered product when the associated product information is displayed through at least one of a personal page, a shopping information service, and a web document searching service.

7. The method of claim 6, wherein the associated product information of the registered product is displayed through a social networking service provided through the portal site system, and
the processing a paying further processes a payment related to the sale of the registered product while the associated product information is displayed through the social networking service.

8. The method of claim 6 further comprising:
providing a social networking service, and
rewarding with a reward at least one of a portal site member or a user subscribing to the payment service as a member, when the registered product is purchased after the associated product information is uploaded on the social networking service by at least one of the portal site member or the user subscribing to the payment service as the member.

9. The method of claim 8, wherein the reward is provided to a user uploading the associated product information of the registered product through the social networking service for a first time.

10. The method of claim 6, wherein the sale of the registered product is conducted on the personal page.

11. One or more non-transitory computer-readable storage media having stored thereon a computer program that, when executed by one or more processors, causes the one or more processors to perform acts that provide an advertisement, comprising:
receiving information about a product input to a personal page assigned to a portal site member subscribing the personal page managing service;
registering, in a storage unit, the product and associated product information; and
processing a payment related to sale of the registered product when the associated product information is displayed through at least one of a personal page, a shopping information service, and a web document searching service.

12. The system of claim 1, wherein the receiving of information, the registering of the product, and the processing of a payment is integrated.
